(19) United States
(12) Patent Application Publication
(10) Pub. No.: US 2010/0201926 A1
(43) Pub. Date: Aug. 12, 2010

(54) Backside-illuminated image sensor and method of forming the same

(75) Inventor: Yun Ki Lee, Seoul (KR)

Correspondence Address: HARNESS, DICKEY & PIERCE, P.L.C., P.O. BOX 8910, RESTON, VA, 20195, US

(73) Assignee: Samsung Electronics Co., Ltd.

(21) Appl. No.: 12/654,342

(22) Filed: Dec. 17, 2009

(30) Foreign Application Priority Data
Feb. 9, 2009 (KR) 10-2009-0010224

(51) Int. Cl. G02F 1/1335

(52) U.S. Cl. 349/108

(57) ABSTRACT

The backside-illuminated image sensor may include a substrate having a first substrate surface, a second substrate surface to which light is incident, and a plurality of pixel regions. The sensor may also include a photoelectric conversion unit in the substrate, multi-layered interconnections and interlayer dielectrics over the first substrate surface, a plurality of color filters corresponding to the respective pixel regions over the second surface, and a plurality of microlenses over the respective color filters. A first type of color filter of the plurality of color filters may be of a first color having a wavelength that is longest among a remaining type of color filters of the plurality of color filters and include a first filter surface adjacent to the second substrate surface and a second filter surface opposite to the first filter surface, a width of the first filter surface narrower than that of the second filter surface.

### CROSS-REFERENCE TO RELATED APPLICATIONS

This U.S. non-provisional patent application claims priority under 35 U.S.C. §119 of Korean Patent Application No. 10-2009-0010224, filed on Feb. 9, 2009, in the Korean Intellectual Property Office (KIPO), the entire contents of which are herein incorporated by reference.

### BACKGROUND

1. Technical Field

Example embodiments relate to an image sensor and a method of forming the same, for example, to a backside-illuminated image sensor and a method of forming the same.

2. Description of Related Art

In a fabrication process of image sensors, such as typical CMOS image sensors, transistors are formed on a semiconductor substrate in which a photodiode is formed for each pixel, and multi-layered metal interconnections and interlayer dielectrics are formed on the transistor. Also, color filters and microlenses are formed on the interlayer dielectrics.

In such a typical image sensor having the above structure, light from a microlens passes through many layers of interlayer dielectrics until the light reaches a photodiode, and the light may be reflected or blocked by the metal interconnections at a plurality of levels, reducing light condensing efficiency. Thus, image quality brightness may be reduced.

To overcome the above limitations, backside-illuminated image sensors receiving light through the back side thereof have been proposed. However, typical backside-illuminated image sensors have a limitation of crosstalk between pixels due to diffraction of light. The crosstalk may increase with light wavelength increases and higher integration of the image sensor.

### SUMMARY

Example embodiments provide a backside-illuminated image sensor capable of preventing or reducing crosstalk. Example embodiments also provide a method of forming a backside-illuminated image sensor capable of preventing crosstalk.

According to example embodiments, a backside-illuminated image sensor may include a substrate, a photoelectric conversion unit, multi-layered interconnections and interlayer dielectrics, a plurality of color filters, and a plurality of microlenses. The substrate may include a first substrate surface, a second substrate surface to which light is incident, and a plurality of pixel regions. The photoelectric conversion unit may be in the substrate. The multi-layered interconnections and interlayer dielectrics may be over the first substrate surface. The plurality of color filters may correspond to the respective pixel regions over the second surface. The plurality of microlenses may be over the respective color filters. The first type of color filter of the plurality of color filters may be of a first color having a wavelength that is longest among a remaining type of color filters of the plurality of color filters. The first type of color filter may include a first filter surface adjacent to the second substrate surface and a second filter surface opposite to the first filter surface, where a width of the first filter surface is narrower than that of the second filter surface.

In example embodiments, a second type of color filter of the plurality of color filters may be of a second color having a wavelength that is different than that of the first type of color filter. The second type of color filter may include a sloped sidewall profile contacting a side surface of the first type of color filter.

In example embodiments, the microlens may have a height-to-width ratio ranging from about 0.3 to about 0.5.

In example embodiments, a third type of color filter of the plurality of color filters may be of a third color. The second color may be a wavelength greater than a wavelength of the third color and less than a wavelength of the first color.

In example embodiments, the first filter surface of the first type of color filter may be smaller in area than a surface of the second type of color filter adjacent to the second substrate surface. A surface of the third type of color filter adjacent to the second substrate surface may be smaller in area than a surface of the second type of color filter adjacent to the second substrate surface. The first filter surface of the first type of color filter may be equal in area to a surface of the third type of color filter adjacent to the second substrate surface.

According to example embodiments, a backside-illuminated image sensor may include a substrate and a plurality of color filters. The substrate may include a first substrate surface, a second substrate surface to which light is incident, and a plurality of pixel regions. The plurality of color filters may correspond to the respective pixel regions over the second surface. A first type of color filter of the plurality of color filters may be of a first color having a wavelength that is longest among a remaining type of color filters of the plurality of color filters. The first type of color filter may include a first filter surface adjacent to the second substrate surface and a second filter surface opposite to the first filter surface, where a width of the first filter surface is narrower than that of the second filter surface.

According to example embodiments, a method of fabricating a backside-illuminated image sensor may include preparing a substrate including a first substrate surface, a second substrate surface to which light is incident, and a plurality of pixel regions, forming a plurality of photoelectric conversion units in the substrate, forming multi-layered interconnections and interlayer dielectrics over the first substrate surface, and forming a plurality of color filters in positions corresponding to the respective pixel regions over the second substrate surface. A first type of color filter of the plurality of color filters may be of a first color having a wavelength that is longest among a remaining type of color filters of the plurality of color filters. The first type of color filter may include a first filter surface adjacent to the second substrate surface and a second filter surface opposite to the first filter surface, where a width of the first filter surface is narrower than that of the second filter surface.

In example embodiments, the forming the plurality of color filters may include forming the first type of color filter, and forming a second type of color filter of the plurality of color filters that is of a second color having a wavelength that is different than that of the first type of color filter, the second type of color filter including a sloped sidewall profile contacting a side surface of the first type of color filter.

In example embodiments, the forming the second color filter includes coating a negative-type photoresist layer including a dye of the second color over the second substrate surface, performing a baking process on the photoresist layer, performing an over-exposure process on the photoresist layer, and developing the photoresist layer.

In example embodiments, the forming the second color filter includes coating a positive-type photoresist layer including a dye of the first color over the second substrate surface, performing a baking process on the photoresist layer, performing an over-exposure process on the photoresist layer, and developing the photoresist layer.

In example embodiments, the method further includes forming a microlens over the first type of color filter.

The first substrate surface may be a front side of the substrate and the second substrate surface may be a back (rear) side.

### BRIEF DESCRIPTION OF THE DRAWINGS

The accompanying drawings are included to provide a further understanding of example embodiments, and are incorporated in and constitute a part of this specification. The drawings illustrate example embodiments and, together with the description, serve to explain principles of example embodiments. In the drawings:

FIG. 1 is a plan view illustrating an arrangement of the lower surfaces of color filters at an incident side of light in a backside-illuminated image sensor according to example embodiments;

FIG. 2 is a plan view illustrating an arrangement of the upper surfaces of color filters in a backside-illuminated image sensor according to example embodiments;

FIG. 3 is a cross-sectional view taken along line I-I of FIG. 1 according to example embodiments;

FIG. 4 is a cross-sectional view taken along line II-II of FIG. 1 according to example embodiments;

FIGS. 5 through 7 are cross-sectional views illustrating a method of forming a semiconductor substrate including a photoelectric conversion unit and an interconnection layer according to example embodiments;

FIG. 8 is a plan view illustrating an arrangement of the lower surfaces of a first color filter according to example embodiments;

FIG. 9 is a cross-sectional view taken along line I-I of FIG. 8;

FIG. 10 is a cross-sectional view illustrating a process of forming the structure of FIG. 9;

FIG. 11 is a plan view illustrating an arrangement of the lower surfaces of first and second color filters according to example embodiments;

FIG. 12 is a cross-sectional view taken along line I-I of FIG. 11;

FIG. 13 is another plan view illustrating a second color filter formed on a reflection-preventing layer according to example embodiments;

FIG. 14 is a cross-sectional view taken along line I-I of FIG. 12;

FIG. 15 is a cross-sectional view illustrating a process of forming the structure of FIG. 14;

FIG. 16 is a view illustrating a simulated light distribution in a structure of a backside-illuminated image sensor according to example embodiments;

FIG. 17 is another plan view illustrating an arrangement of the upper surfaces of color filters in a backside-illuminated image sensor according to example embodiments;

FIG. 18 is another cross-sectional view taken along line II-II of FIG. 1 or 17 according to example embodiments;

FIG. 19 is another cross-sectional view taken along line I-I of FIG. 1 or 17 according to example embodiments;

FIG. 20 is another plan view illustrating an arrangement of the lower surfaces of second and third color filters according to example embodiments; and

FIG. 21 is a cross-sectional view taken along line II-II of FIG. 20.

### DETAILED DESCRIPTION

Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but on the contrary, example embodiments are to cover all modifications, equivalents, and alternatives falling within the scope of example embodiments.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.).

Spatially relative terms, such as “beneath,” “below,” “lower,” “above,” “upper,” and the like may be used herein for ease of description to describe the relationship of one component and/or feature to another component and/or feature, or other component(s) and/or feature(s), as illustrated in the drawings. It will be understood that the spatially relative terms are intended to encompass different orientations of the device in use or operation in addition to the orientation depicted in the figures. The figures are intended to depict example embodiments and should not be interpreted to limit the intended scope of the claims. The accompanying figures are not to be considered as drawn to scale unless explicitly noted.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising,” “includes” and/or “including”, when used herein, specify the presence of stated features, integers, steps, operations, elements, and/or components, but do not preclude the presence or addition of one or more other features, integers, steps, operations, elements, components, and/or groups thereof. In this specification, the term “and/or” picks out each individual item as well as all combinations of them.

Example embodiments are described herein with reference to cross-section illustrations that are schematic illustrations of idealized embodiments (and intermediate structures). As such, variations from the shapes of the illustrations as a result, for example, of manufacturing techniques and/or tolerances, are to be expected. Thus, embodiments should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of example embodiments.

Unless otherwise defined, all terms (including technical and scientific terms) used herein have the same meaning as commonly understood by one of ordinary skill in the art to which example embodiments belongs. It will be further understood that terms, such as those defined in commonly used dictionaries, should be interpreted as having a meaning that is consistent with their meaning in the context of the relevant art and should not be interpreted in an idealized or overly formal sense unless expressly so defined herein.

It should also be noted that in some alternative implementations, the functions/acts noted may occur out of the order noted in the FIGS. For example, two FIGS. shown in succession may in fact be executed substantially concurrently or may sometimes be executed in the reverse order, depending upon the functionality/acts involved.

Now, in order to more specifically describe example embodiments, example embodiments will be described in detail with reference to the attached drawings. However, example embodiments are not limited to the embodiments described herein, but may be embodied in various forms.

When it is determined that a detailed description related to a related known function or configuration may make the purpose of example embodiments unnecessarily ambiguous, the detailed description thereof will be omitted. Also, terms used herein are defined to appropriately describe example embodiments and thus may be changed depending on a user, the intent of an operator, or a custom. Accordingly, the terms must be defined based on the following overall description within this specification.

In the drawings, the dimensions of layers and regions are exaggerated for clarity of illustration. It will also be understood that when a layer (or film) is referred to as being ‘on’ another layer or substrate, it can be directly on the other layer or substrate, or intervening layers may also be present. Further, it will be understood that when a layer is referred to as being ‘under’ another layer, it can be directly under, and one or more intervening layers may also be present. In addition, it will also be understood that when a layer is referred to as being ‘between’ two layers, it can be the only layer between the two layers, or one or more intervening layers may also be present. Like reference numerals refer to like elements throughout.

Hereinafter, example embodiments will be described in detail with reference to the accompanying drawings.

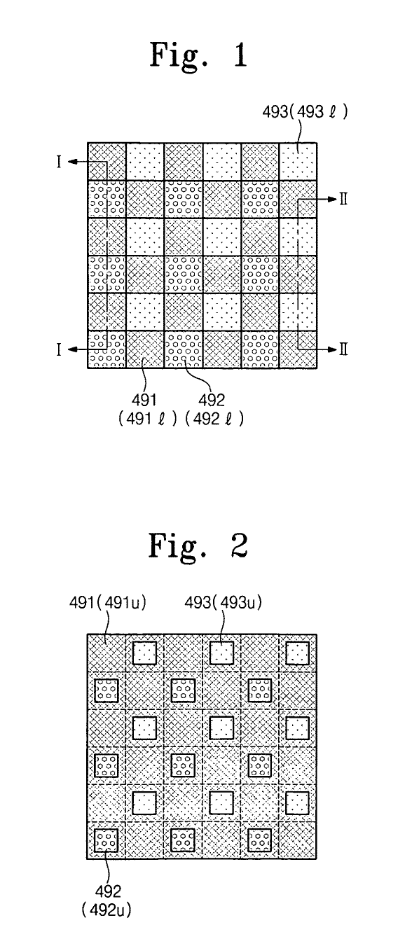

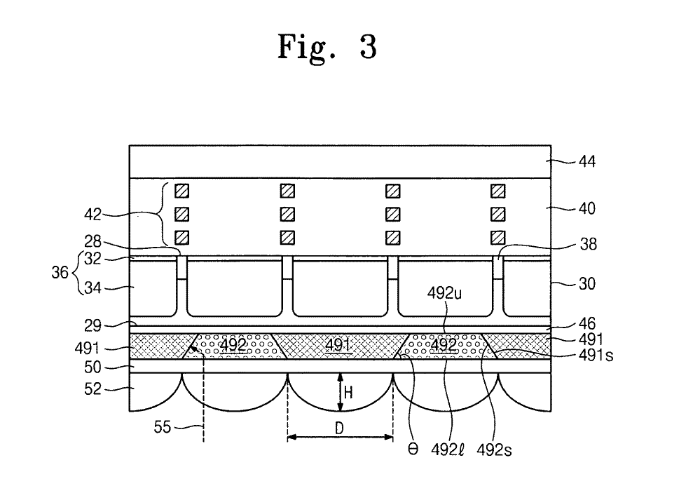

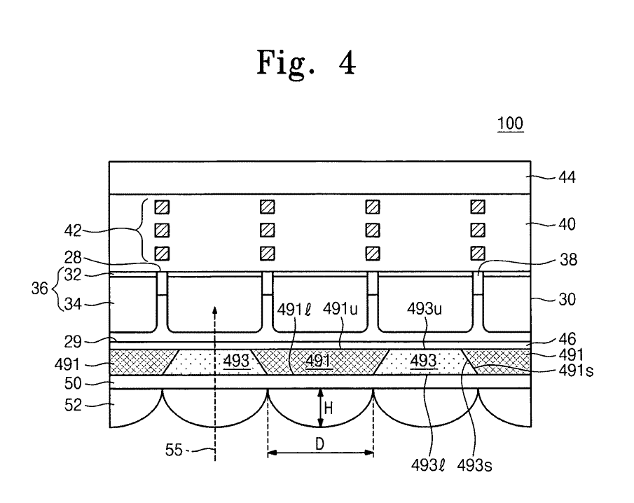

FIG. 1 is a plan view illustrating an arrangement of the lower surfaces of color filters as an incident side of light in a backside-illuminated image sensor according to example embodiments. FIG. 2 is a plan view illustrating an arrangement of the upper surfaces of color filters in a backside-illuminated image sensor according to example embodiments. FIG. 3 is a cross-sectional view taken along line I-I of FIG. 1 according to example embodiments. FIG. 4 is a cross-sectional view taken along line II-II of FIG. 1 according to example embodiments.

Referring to FIGS. 3 and 4, the backside-illuminated image sensor includes a semiconductor substrate 30 in which a front side 28 and a back side 29 are defined. Device isolation layers 38 defining active regions of respective pixels are disposed in the semiconductor substrate 30. A photoelectric conversion unit 36 including at least two impurity layers 32 and 34 doped with the opposite type of different impurities is disposed in the active region of respective pixel of the semiconductor substrate 30. A plurality of transistors (not shown) is disposed over a portion of the photoelectric conversion unit 36. A multi-layered interconnection 42 and interlayer dielectric 40 are disposed over the front side 28 of the semiconductor substrate 30. A supporting substrate 44 may be disposed over the interlayer dielectric 40.

A reflection-preventing layer 46 may be disposed under the back side 29 of the semiconductor substrate 30. Color filters 491, 492 and 493 are disposed under the reflection-preventing layer 46. The color filters 491, 492 and 493 may include a first color filter 491, a second color filter 492, and a third color filter 493. For example, the first color filter 491 may be a green color filter, the second color filter 492 may be a red color filter, and the third color filter 493 may be a blue color filter. In this case, the wavelength of the red light is the longest, and the wavelength of the blue light is the shortest. The first color filter 491 has a lower surface 4911 to which light is incident, an upper surface 491u, and a sloped sidewall 491s. The second color filter 492 has a lower surface 4921 to which light is incident, an upper surface 492u, and a sloped sidewall 492s. The third color filter 493 has a lower surface 4931 to which light is incident, and upper surface 493u, and a sloped sidewall 493s. The sidewalls 491s, 492s and 493s are engaged with another.

As illustrated in FIG. 1, the respective lower surfaces 4911, 4921, 4931 of the color filters 491, 492, 493 are same to each other in size. However, as illustrated in FIG. 2, the area and width of the upper surface 491u of the first color filter 491 is greater than that of the upper surface 492u of the second color filter 492 and the upper surface 493u of the third color filter 493. The upper surface 492u of the second color filter 492 has the same size as the upper surface 493u of the third color filter 493, and is smaller in size than the upper surface 491u of the first color filter 491. Thus, the second color filter 492 of the longest wavelength is formed to have the lower surface 4921 to which light is incident and the upper surface 492u having a smaller size than the lower surface 4921, thereby having the sloped sidewall 492s. An angle θ between the sloped sidewall 492s and the lower surface 4921 of the second color filter may range from about 30° to about 89°. In contrast, the first color filter 491 contacted with the second color filter 492 has a larger upper surface 491u than the lower surface 4911. In this example embodiment, the third color filter 493 may have a shape similar to the second color filter 492.

A limitation due to the diffraction of light having a long wavelength in a color filter having a vertical sidewall profile may be overcome by the above structure. For example, as illustrated in FIGS. 3 and 4, when light 55 is incident to the back side of the semiconductor substrate 30, long wavelength light, for example, red light is blocked by the sloped sidewall 491s of the first color filter 491 adjacent to the second color filter 492 even when the red light is diffracted, as shown by the arrow 55 in FIG. 3. This is because the transmittance of the red light is very small with respect to a green or blue color filter. Accordingly, the long wavelength light incident to an adjacent pixel due to the diffraction in the second color filter 492 is blocked to prevent or reduce crosstalk. Thus, light of each of the colors corresponding to the color filters 491, 492 and 493 may be incident to the corresponding photoelectric conversion unit 36.

Referring again to FIGS. 3 and 4, a planarization layer 50 may be disposed under the color filters 491, 492 and 493. Microlenses 52 are disposed corresponding to the respective pixels under the planarization layer 50. The ratio of the height to the width of the microlenses 52 may range from about 0.3 to about 0.5. Thus, the reduction of the light-condensing efficiency that may be generated may be complemented by the narrower upper surfaces 492u and 493u of the second and third color filters 492 and 493.

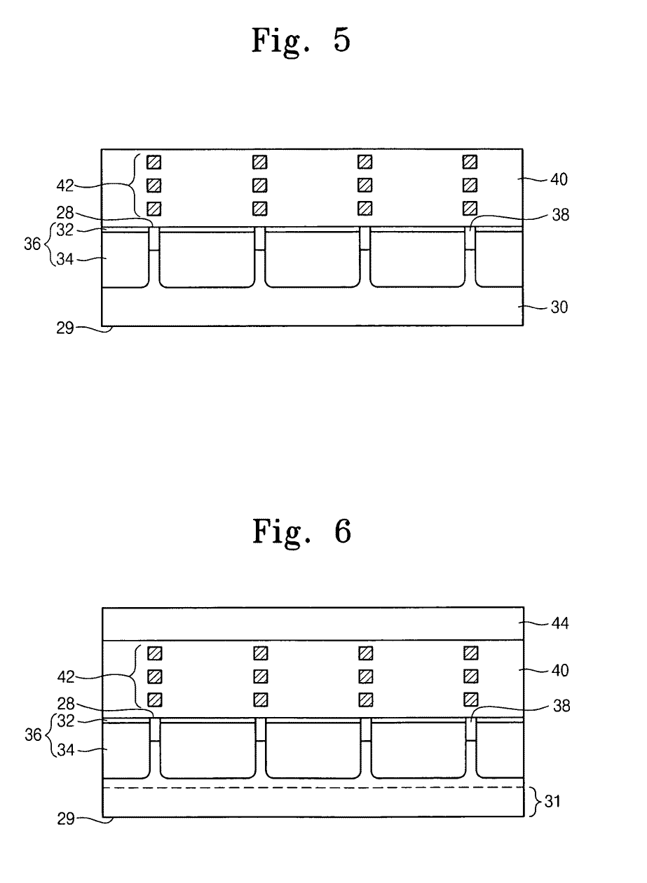

Hereinafter, a method of forming the backside-illuminated image sensor described with reference with FIGS. 1 through 4 will be described in detail with reference to FIGS. 5 through 12.

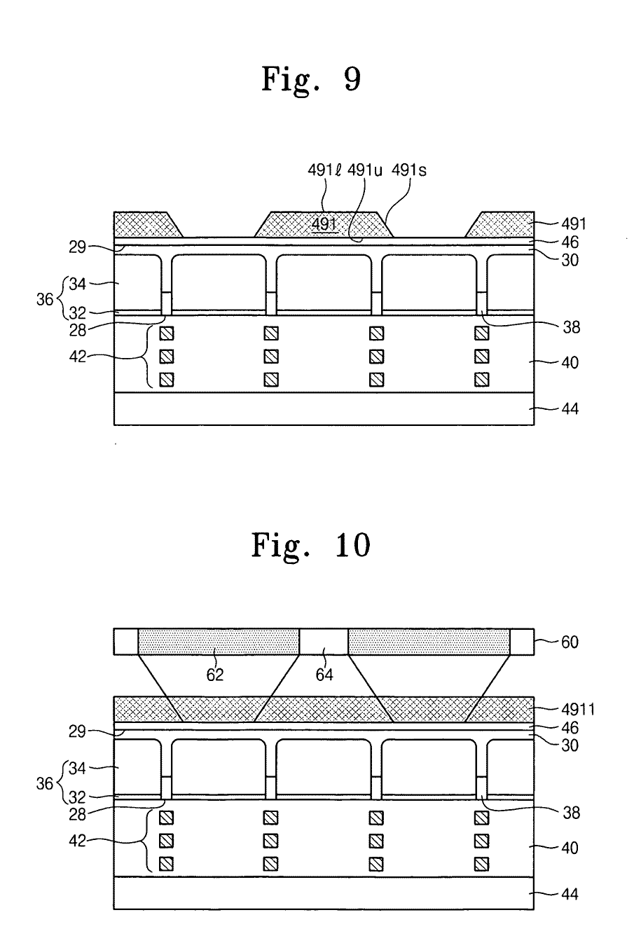

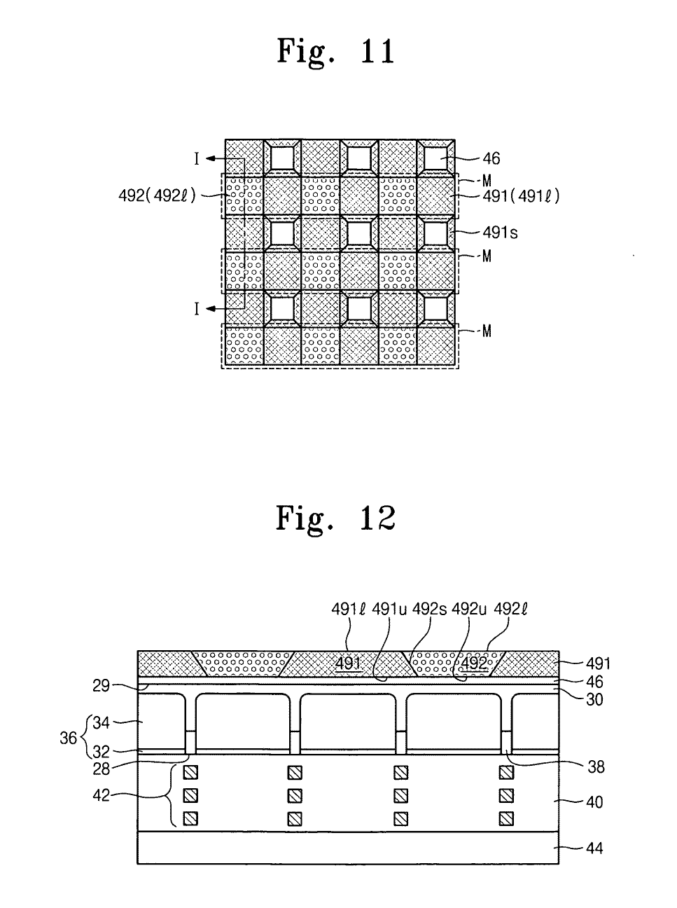

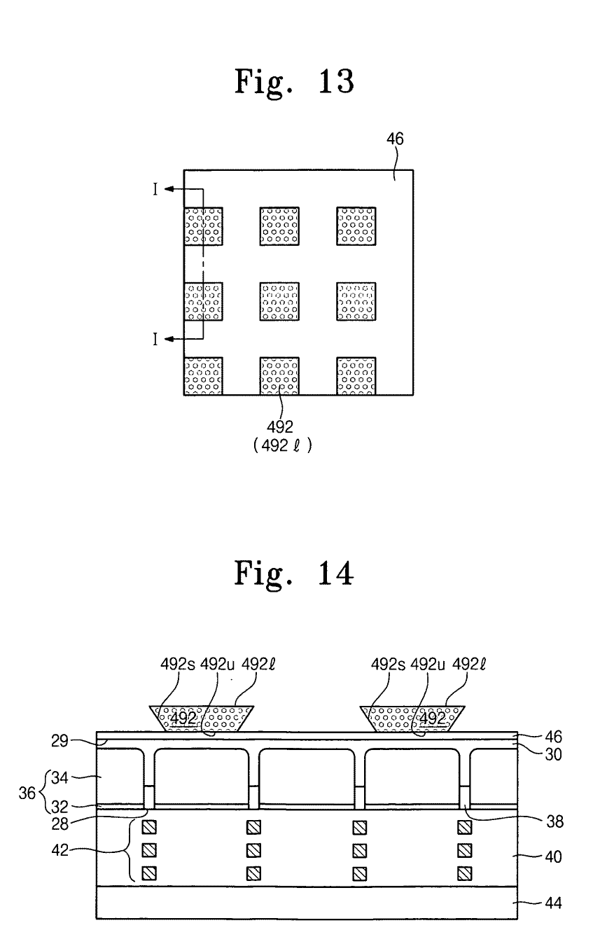

FIGS. 5 through 7 are cross-sectional views illustrating a method of forming a semiconductor substrate including a photoelectric conversion unit and an interconnection layer according to example embodiments. FIG. 8 is a plan view illustrating an arrangement of the lower surfaces of a first color filter according to example embodiments. FIG. 9 is a cross-sectional view taken along line I-I of FIG. 8. FIG. 10 is a cross-sectional view illustrating a process of forming the structure of FIG. 9. FIG. 11 is a plan view illustrating an arrangement of the lower surfaces of first and second color filters according to example embodiments. FIG. 12 is a cross-sectional view taken along line I-I of FIG. 11.

Referring to FIG. 5, a well (not shown) is formed by doping a semiconductor substrate 30 defining a front side 28 and a back side 29 with first type impurities. Active regions of pixels are defined by forming device isolation layers 38 in the semiconductor substrate 30. For example, the device isolation layers 38 may be formed through a typical shallow trench isolation method. A photoelectric conversion unit 36 including a second impurity implantation region 34 and a first impurity implantation region 32 is formed by performing, at least twice, ion implantation on the respective pixels defined by the device isolation layers 38. For example, the second impurity implantation region 34 may be formed by implanting arsenic (As) at a dose of about 1×10¹² atoms/cm². The first impurity implantation region 32 may be formed by implanting boron fluoride (BF₂) at a dose of about 1×10¹³ atoms/cm². Although not shown, a transfer transistor for transferring electric charges, a reset transistor, a select transistor, and an access transistor may be formed after the forming of the photoelectric conversion unit 36. Then, a multi-layered interconnection 42 and interlayer dielectric 40 are formed over the front side 28 of the semiconductor substrate 30.

Referring to FIG. 6, a supporting substrate 44 is bonded to the interlayer dielectric 40 of the semiconductor substrate 30 in which the interconnection process is completed. The supporting substrate 44 may be directly attached onto the interlayer dielectric 40. Alternatively, the supporting substrate 44 may be attached onto the interlayer dielectric 40 with a glue layer interposed therebetween. When the glue layer is interposed between the supporting substrate 44 and the interlayer dielectric 40, a portion 31 of the back side 29 of the semiconductor substrate 30 is removed. The removal process may be performed through a mechanical grinding, a Chemical Mechanical Polishing (CMP), a front side etch back, or a wet etch.

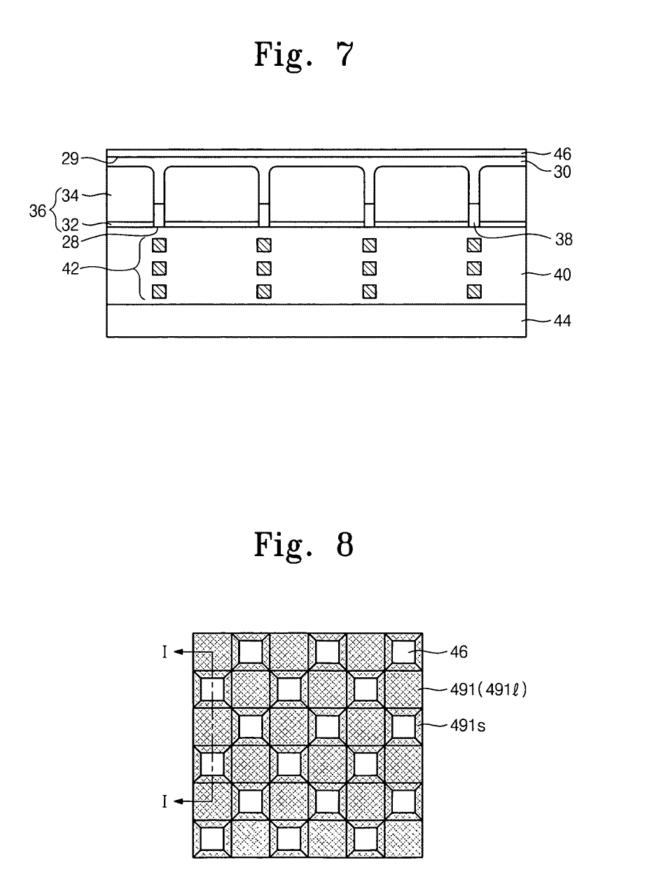

Referring to FIG. 7, the semiconductor substrate 30 from which the portion 31 of the back side 29 is removed and reversed. Thus, the front side 28 of the semiconductor substrate 30 is located downward, and the back side 29 of the semiconductor substrate 30 is located upward. A reflection-preventing layer 46 is formed on the back side 29. For example, the reflection-preventing layer 46 may be a silicon nitride (SiN), silicon oxide, or a combination thereof.

Referring to FIGS. 8 through 10, a first color filter 491 is formed on the reflection-preventing layer 46. The first color filter 491 may be formed by a method described in FIG. 10. For example, referring to FIG. 10, after a photoresist 4911 including a first color dye is coated on the back side 29 of the semiconductor substrate 30, a soft baking is performed thereon. For example, the photoresist 4911 may be a negative type. An exposure process is performed on the photoresist 4911 using a photomask 60 including a light-blocking part 62 and a light-transmitting part 64. Thus, the photoresist 4911 receives light selectively. A region of the negative photoresist 4911 to which light is incident through the light-transmitting part 64 becomes insoluble in a developing solution, and an other region of the negative photoresist 4911 to which the light is not incident is readily soluble in the developing solution. For example, the exposure process may be performed through an over-exposure. Light may be obliquely incident to the photoresist 4911 due to the over-exposure process and the diffusion of light. If the exposure process is completed, a developing process is subsequently performed, leaving only a photoresist pattern having a sloped sidewall profile 491s, for example, a first color filter 491 as described in FIGS. 8 and 9. The undersurfaces of the first color filters 491 may be connected to each other for each pixel as described in FIG. 4.

Referring to FIGS. 11 and 12, a second color filter 492 is formed on the back side 29 of the semiconductor substrate 30 on which the first color filter 491 is formed. To form the second color filter 492, after a photoresist (not shown) including a second color dye is overall coated, a soft baking is performed thereon. For example, the photoresist 4921 may be a positive type. In this case, an exposure process is performed using a mask M having a line-shaped light-blocking pattern that connects between the first color filter 491 and the second color filter 492. Subsequently, the second color photoresist of a region exposed by the mask M is removed by a developing solution. Thus, the second color filter 492 may be formed to have a lower surface 4921 and an upper surface 492u having a narrower width than the lower surface 492. In FIG. 12, the lower surface 4921 is located above the upper surface 492u because the semiconductor substrate 30 is reversed for convenience of processing.

Referring again to FIGS. 1, 2, and 4, a third color filter 493 is formed on the back side 29 of the semiconductor substrate 30 on which the first and second color filters 491 and 492 are formed. To form the third color filter 493, after a photoresist including a third color dye is overall coated, a soft baking is performed thereon. Then, selective exposure and developing processes may be performed. Alternatively, without the exposure and developing processes, after the photoresist including the third color dye is overall coated and soft-baked, a planarization process may be performed to expose the first and second color filters 491 and 492 and simultaneously form the third color filters 493 in a space between the first color filters 491.

Referring to FIGS. 3 and 4, a planarization layer 50 may be formed on the color filters 491, 492 and 493. Microlenses 52 are formed on the planarization layer 50 in alignment with the respective pixel regions. The microlenses 52 may be formed by forming a photoresist pattern (not shown) including a transparent acryl resin through a photo process and reflowing the photoresist pattern by heat. The ratio of the height to the width of the microlenses 52 may range from about 0.3 to about 0.5.

If the semiconductor substrate 30 is again reversed after the above processes, the shape thereof may be similar or identical to that of FIGS. 3 and 4.

The color filters 491, 492 and 493 of the backside-illuminated image sensor described in FIGS. 1 through 4 may be formed differently from the process order described in FIGS. 5 through 12. For example, in the above example embodiment of the fabrication method, after the first color filter 491 is formed, the second color filter 492 and the third color filter 493 are sequentially formed. However, in this example embodiment, after the second color filter 492 is formed, the first color filter 491 and the third color filter 493 are sequentially formed.

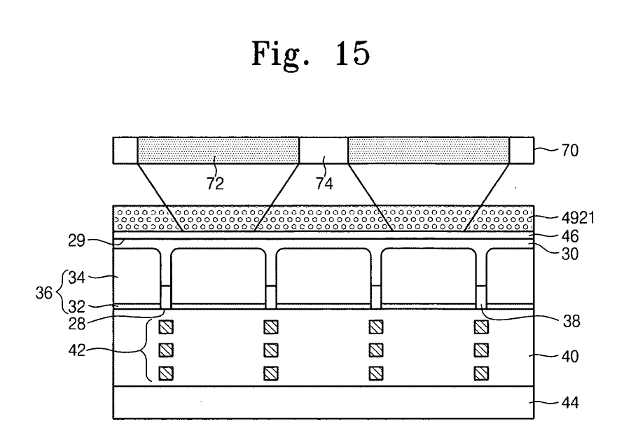

FIG. 13 is another plan view illustrating a second color filter formed on a reflection-preventing layer according to example embodiments. FIG. 14 is a cross-sectional view taken along line I-I of FIG. 12. FIG. 15 is a cross-sectional view illustrating a process of forming the structure of FIG. 14.

Referring to FIGS. 13 through 15, a second color filter 492 is formed on the back side 29 of the semiconductor substrate 30 on which the reflection-preventing layer 46 is formed as described FIG. 7. To form the second color filter 492, as described in FIG. 15, after a photoresist 4921 of the positive type including the second color dye is coated on the reflection-preventing layer 46, a soft baking is performed thereon. After a photomask 70 including a light-blocking part 72 and a light-transmitting part 74 is arranged on the photoresist 4921, an exposure process is performed. Since the photoresist 4921 is the positive type, a portion of the photoresist 4921 that receive light may readily be turned soluble in a developing solution. If a developing process is subsequently performed, the second color filter 492 as described in FIG. 2 may be formed.

Alternatively, the photoresist 4921 may be the negative type. In this case, an under-exposure process may be performed to form the second color filter 492. The second color filter 492 may be formed to have a lower surface 4921, an upper surface 492u having a narrower width than the lower surface 4921, and a sloped sidewall 492s

Referring to FIGS. 11 and 12, a first color filter 491 is formed on the reflection-preventing layer 46 on which the second color first 492 is formed. The first color filter 491 may be formed through soft baking, over-exposure, and development processes after a photoresist layer of the negative type is coated on the reflection-preventing layer 46 on which the second color filter 492 is formed.

Referring again to FIGS. 1, 2, and 4, after the second color filter 492 is formed, a third color filter 493 is formed. A method of forming the third color filter 493 may be similar or identical to that described in above example embodiment of the fabrication method.

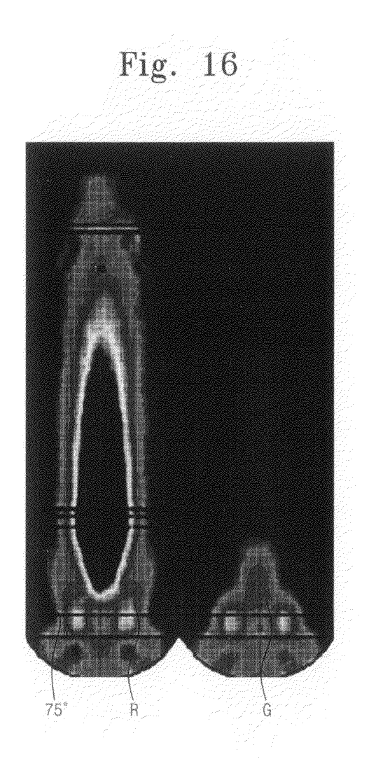

FIG. 16 is a view illustrating a simulated light distribution in a structure of a backside-illuminated image sensor according to example embodiments.

Referring to FIG. 16, on the left side, the distribution of light incident through a microlens is illustrated when an angle θ between the lower surface and the sidewall of a red color filter R is about 75°. On the right side, the distribution of light incident through a microlens of a green color filter G is illustrated. It will be understood from FIG. 16 that the diffraction of light is not shown.

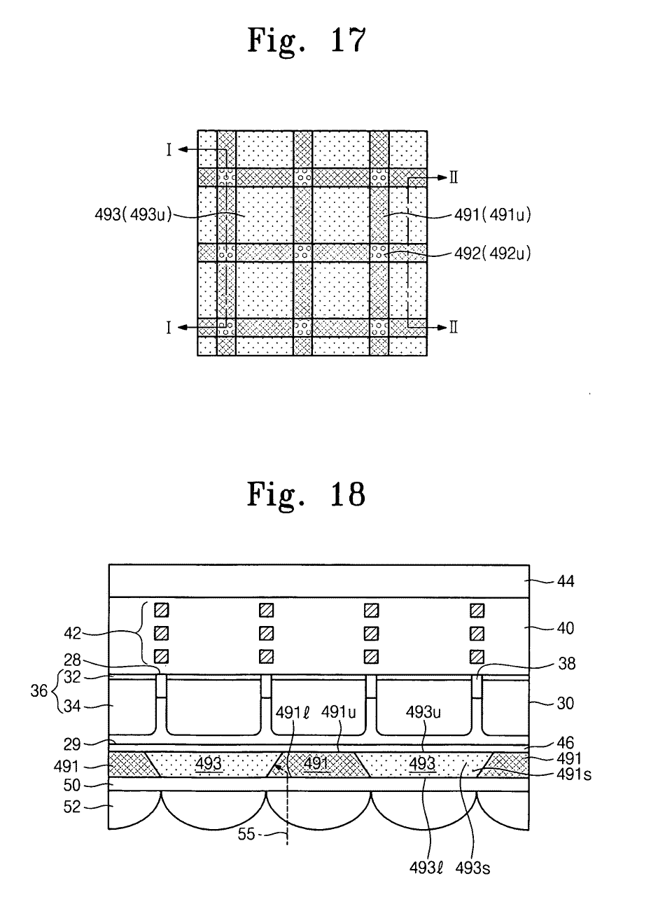

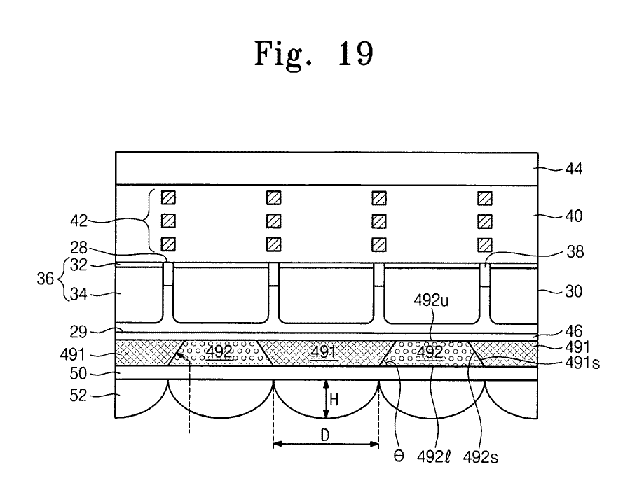

FIG. 17 is another plan view illustrating an arrangement of the upper surfaces of color filters in a backside-illuminated image sensor according to example embodiments. FIG. 18 is another cross-sectional view taken along line II-II of FIG. 1 or 17 according to example embodiments. FIG. 19 is another cross-sectional view taken along line I-I of FIG. 1 or 17 according to example embodiments.

Referring to FIGS. 1, 3, 17, 18, and 19, the shape of a second color filter 492 is similar or identical in both the example embodiment described in FIGS. 1 and 3 and the example embodiment described in FIGS. 17-19, but the structures of the first and third color filters 491 and 493 are different in these example embodiments. For example, in the example embodiment of FIGS. 17-19, the lower surface 4911 of the first color filter 491 has a square shape, and the upper surface 491u of the first color filter 491 has a bar shape. The third color filter 493 includes a lower surface 4931 having a square shape, and an upper surface 493u having a square shape greater in area than the lower surface 4931. From an incident direction of light, the lower surfaces 4911, 4921 and 4931 of the color filters 491, 492 and 493 have an area similar or identical to each other in both the example embodiment described in FIGS. 1-3 and the example embodiment described in FIGS. 17-19. However, in the example embodiment of FIGS. 17-19, the upper surface 493u of the third color filter 493 has the greatest area, and the upper surface 492u of the second color filter 492 has the smallest area, unlike the example embodiment described in FIGS. 1-3. The example embodiment of FIGS. 17-19 may be applied when the second color filter 492 is a red color filter, the first color filter 491 is a green color filter, and the third color filter 493 is a blue color filter. For example, in this example embodiment, as the wavelength of the filter color becomes longer, the areas of the upper surfaces at the side of a reflection-preventing layer become smaller. Thus, sloped boundary surfaces are formed between the color filters 491, 492 and 493 to prevent or reduce the diffraction of light having a long wavelength, thereby preventing or reducing crosstalk.

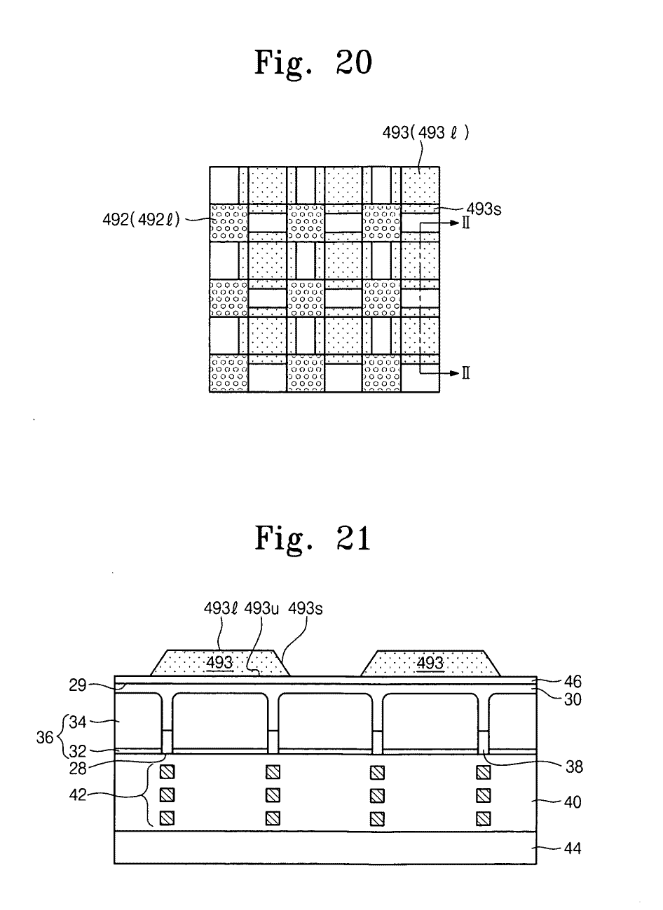

Hereinafter, a method of forming the backside-illuminated image sensor of FIGS. 17-19 will be described. FIG. 20 is another plan view illustrating an arrangement of the lower surfaces of second and third color filters according to example embodiments. FIG. 21 is a cross-sectional view taken along line II-II of FIG. 20.

As described in FIGS. 13 through 15, a second color filter 492 is formed on a reflection-preventing layer 46.

Referring to FIGS. 20 and 21, a third color filter 493 is formed. The third color filter 493 is formed by performing over-exposure and developing processes after a photoresist of the negative type including a third color dye is coated and soft-baked on the reflection-preventing layer 46 on which the second color filter 492.

Referring to FIGS. 1, 3, 17, 18, and 19, after a photoresist layer including a first color dye is coated on the reflection-preventing layer 46 on which the second and third color filters 492 and 493, baking and CMP processes are performed to form a first color filter 491. The other processes are identical to those of the example embodiment of a fabrication method described in FIGS. 5-12.

According to example embodiments, a backside-illuminated image sensor includes a color filter of a longest color wavelength that is formed to allow the width of a surface of the color filter adjacent to another surface of a substrate to be narrower than that of an opposite surface of the color filter, so that the color filter has a sloped sidewall. Thus, a different color filter contacting the color filter of the longest color wavelength is formed to have an oppositely sloped side wall contacting the sloped sidewall thereof. A color having a long wavelength shows lower transmittance than a color having a short wavelength. Thus, light diffracted into the sloped sidewall of the color filter of the longest color wavelength may not transmit another color filter, thereby preventing or reducing crosstalk.

Also, according to example embodiments, a backside-illuminated image sensor includes a plurality of microlenses of color filters that are formed to allow a ratio of the height to the width to range from about 0.3 to about 0.5., thereby increasing light-condensing efficiency. Thus, the reduction of the light-condensing efficiency due to a narrow surface of the color filter of a longest color wavelength can be complemented.

The above-disclosed subject matter is to be considered illustrative and not restrictive, and the appended claims are intended to cover all such modifications, enhancements, and other embodiments, which fall within the true spirit and scope of example embodiments. Thus, to the maximum extent allowed by law, the scope of the inventive concept is to be determined by the broadest permissible interpretation of the following claims and their equivalents, and shall not be restricted or limited by the foregoing detailed description.

1. An image sensor comprising:
a substrate including a first substrate surface, a second substrate surface to which light is incident, and a plurality of pixel regions;
a photoelectric conversion unit in the substrate;
multi-layered interconnections and interlayer dielectrics over the first substrate surface;
a plurality of color filters corresponding to the respective pixel regions over the second surface; and
a plurality of microlenses over the respective color filters, wherein, a first type of color filter of the plurality of color filters is of a first color having a wavelength that is longest among a remaining type of color filters of the plurality of color filters, and
the first type of color filter includes a first filter surface adjacent to the second substrate surface and a second filter surface opposite to the first filter surface, where a width of the first filter surface is narrower than that of the second filter surface.

2. The image sensor of claim 1, wherein,
a second type of color filter of the plurality of color filters is of a second color having a wavelength that is different than that of the first type of color filter, and
the second type of color filter includes a sloped sidewall profile contacting a side surface of the first type of color filter.

3. The image sensor of claim 2, wherein the microlens has a height-to-width ratio ranging from about 0.3 to about 0.5.

4. The image sensor of claim 2, wherein,
a third type of color filter of the plurality of color filters is of a third color, and
the second color has a wavelength greater than a wavelength of the third color and less than a wavelength of the first color.

5. The image sensor of claim 4, wherein,
the first filter surface of the first type of color filter is smaller in area than a surface of the second type of color filter adjacent to the second substrate surface.

6. The image sensor of claim 5, wherein,
a surface of the third type of color filter adjacent to the second substrate surface is smaller in area than a surface of the second type of color filter adjacent to the second substrate surface.

7. The image sensor of claim 6, wherein,
the first filter surface of the first type of color filter is equal in area to a surface of the third type of color filter adjacent to the second substrate surface.

8. The image sensor of claim 4, wherein,
a surface of the third type of color filter adjacent to the second substrate surface is smaller in area than a surface of the second type of color filter adjacent to the second substrate surface.

9. The image sensor of claim 4, wherein,
the first filter surface of the first type of color filter is equal in area to a surface of the third type of color filter adjacent to the second substrate surface.

10. The backside-illuminated image sensor of claim 4, wherein,
the first filter surface of the first type of color filter smaller in area than a surface of the third type of color filter adjacent to the second substrate surface.

11. The backside-illuminated image sensor of claim 1, wherein the microlens has a height-to-width ratio ranging from about 0.3 to about 0.5.

12. A backside-illuminated image sensor comprising:
a substrate including a first substrate surface, a second substrate surface to which light is incident, and a plurality of pixel regions; and
a plurality of color filters corresponding to the respective pixel regions over the second surface, wherein
a first type of color filter of the plurality of color filters is of a first color having a wavelength that is longest among a remaining type of color filters of the plurality of color filters, and
the first type of color filter includes a first filter surface adjacent to the second substrate surface and a second filter surface opposite to the first filter surface, where a width of the first filter surface is narrower than that of the second filter surface.

13. The backside-illuminated image sensor of claim 12, wherein,
a second type of color filter of the plurality of color filters is of a second color having a wavelength that is different than that of the first type of color filter, and
the second type of color filter includes a sloped sidewall profile contacting a side surface of the first type of color filter.

14. The backside-illuminated image sensor of claim 13 wherein,
the first filter surface of the first type of color filter is smaller in area than a surface of the second type of color filter adjacent to the second substrate surface.

15. The backside-illuminated image sensor of claim 14, wherein the microlens has a height-to-width ratio ranging from about 0.3 to about 0.5.

16-21. (canceled)
